(19) United States
(12) Patent Application Publication
(10) Pub. No.: US 2013/0276283 A1
(43) Pub. Date: Oct. 24, 2013

(54) INJECTOR CUP UNIT FOR CONNECTING FUEL INJECTION PIPE AND METHOD OF FABRICATING THE SAME

(71) Applicant: ILJIN STEEL CORPORATION, Anyang-si (KR)

(72) Inventors: Sang Won Han, Hwaseong-si (KR); Hee Won Jung, Hwaseong-si (KR); Chang Keun Min, Hwaseong-si (KR); Won Suk Yun, Hwaseong-si (KR)

(73) Assignee: Iljin Steel Corporation, Anyang-si (KR)

(21) Appl. No.: 13/707,871

(22) Filed: Dec. 7, 2012

(30) Foreign Application Priority Data
Apr. 18, 2012 (KR) 10-2012-0040584

(51) Int. Cl. F02M 37/00

(52) U.S. Cl. CPC F02M 37/00
USPC 29/417; 239/533.2

(57) ABSTRACT

There is provided a method of fabricating an injector cup unit for connecting a fuel injection pipe, which includes providing a steel bar in which parent bodies of injector cups and parent bodies of injector holders, integrally formed with the parent bodies of the injector cups, are continuously connected in a longitudinal direction thereof, cutting the steel bar to a preset length to fabricate the parent body of the injector cup and the parent body of the injector holder, and processing the parent body of the injector cup and the parent body of the injector holder to fabricate the injector cup and the injector holder integrally formed with the injector cup.

### CROSS-REFERENCE TO RELATED APPLICATION

This application claims priority to and the benefit of Korean Patent Application No. 10-2012-0040584 filed in the Korean Intellectual Property Office on 18 Apr. 2012, the entire contents of which are incorporated herein by reference.

### BACKGROUND OF THE INVENTION

1. Field of the Invention

The present invention relates to an injector cup unit for connecting a fuel injection pipe and a method of fabricating the injector cup unit, and more particularly, to an injector cup unit and a method of fabricating the injector cup unit, which make it possible to decrease the number of fabrication processes, thereby improving productivity.

2. Description of the Related Art

In general, a fuel injection pipe is connected between a fuel injection pump and an engine to supply fuel to a vehicle, and the fuel pressed by the fuel injection pump is supplied to the engine through the fuel injection pipe.

In particular, a fuel injection pipe of a gasoline direct injection (GDI) engine of a vehicle receives fuel from a fuel injection pump and supplies the fuel at high speed and high pressure to the GDI engine through an injector.

Injector cup units are attached to the fuel injection pipe to distribute fuel to injectors, and each of the injector cup units includes an injector cup and an injector holder.

The injector cup constituting the injector cup unit is machined, and the injector holder is casted.

Then, the injector cup and the injector holder are welded to each other so as to form an injector cup unit. This may cause a decrease in dimension accuracy due to the casting, deformation due to the welding, a productivity decrease due to a complicated process, and a decrease in mechanical properties.

As a result, production costs may be increased, and fuel injection efficiency may be decreased.

Thus, an injector cup unit for connecting a fuel injection pipe, which is configured to efficiently inject fuel at high speed and pressure to an engine from a fuel injection pump and improve productivity, is needed.

### SUMMARY OF THE INVENTION

The present invention provides an injector cup unit for connecting a fuel injection pipe, which injects fuel received from a fuel injection pump and is adapted for improving dimension accuracy and mechanical properties and simplifying a process to improve productivity, and a method of fabricating the injector cup unit.

According to an aspect of the present invention, a method of fabricating an injector cup unit for connecting a fuel injection pipe includes: providing a steel bar in which parent bodies of injector cups and parent bodies of injector holders, integrally formed with the parent bodies of the injector cups, are continuously connected in a longitudinal direction thereof; cutting the steel bar to a preset length to fabricate the parent body of the injector cup and the parent body of the injector holder; and processing the parent body of the injector cup and the parent body of the injector holder to fabricate the injector cup and the injector holder integrally formed with the injector cup.

The steel bar may have a constant cross section and include a recess connection part that is elongated in the longitudinal direction to connect the parent body of the injector cup and the parent body of the injector holder.

The recess connection part may be recessed upward and downward.

The fabricating of the injector cup may include fabricating a fuel communication part communicating with the fuel injection pipe, and fabricating an insertion part coupled to an injector.

The fabricating of the injector holder may include fabricating a coupling part for coupling to an engine.

The providing of the steel bar may include fabricating a coupling part in the injector holder for coupling to an engine.

The fabricating of the injector cup and the injector holder integrally formed with the injector cup may include fabricating recess coupler parts that individually conform with an outer surface of the fuel injection pipe.

The steel bar may be fabricated from a parent body material through at least one of shape rolling, shaped drawing, shape extrusion, and die forging.

The parent body material may include stainless steel.

According to another aspect of the present invention, an injector cup unit for connecting a fuel injection pipe includes: an injector cup configured to inject fuel introduced from the fuel injection pipe, through an injector; and an injector holder integrally formed with the injector cup and comprising a coupling part for coupling to an engine.

The injector cup and the injector holder may be integrated through a connecting recess part recessed upward and downward.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a fuel injection assembly including injector cup units for connecting a fuel injection pipe, according to an embodiment of the present invention;

FIG. 2 is a perspective view illustrating an injector cup unit of FIG. 1;

FIG. 3 is a plan view illustrating the injector cup unit of FIG. 2;

FIG. 4 is a bottom view illustrating the injector cup unit of FIG. 2; and

FIGS. 5 to 7 are perspective views illustrating a process of fabricating an injector cup unit for connecting a fuel injection pipe according to another embodiment of the present invention.

### DETAILED DESCRIPTION OF THE INVENTION

Hereinafter, exemplary embodiments will be described in detail with reference to the accompanying drawings. The spirit and scope of the present invention, however, shall not be construed as being limited to embodiments provided herein. Rather, it will be apparent that other embodiments that fall within the spirit and scope of the present invention may be easily derived through adding, modifying, and deleting elements herein by those skilled in the art.

In the drawings, like reference numerals denote like elements.

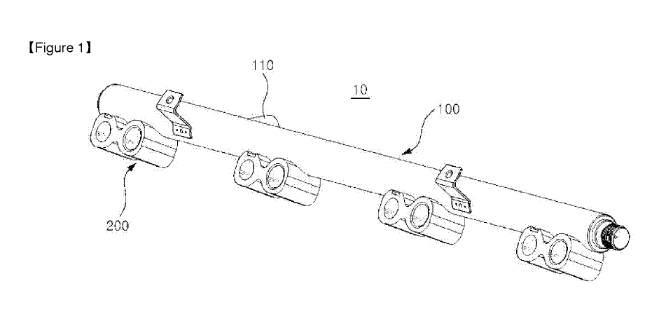

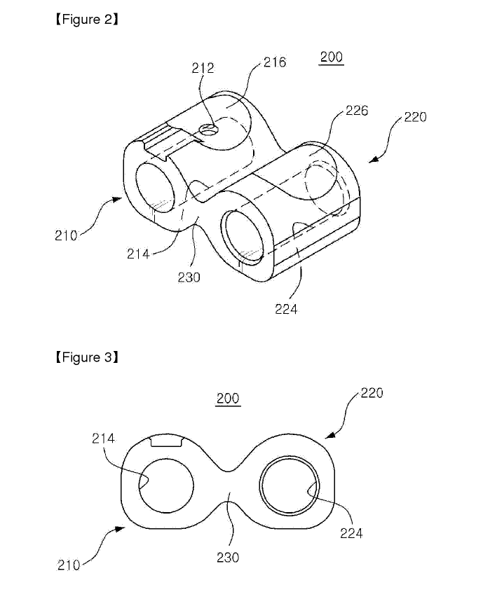

FIG. 1 is a perspective view illustrating a fuel injection assembly including injector cup units for connecting a fuel injection pipe, according to an embodiment of the present invention. FIG. 2 is a perspective view illustrating an injector cup unit of FIG. 1.

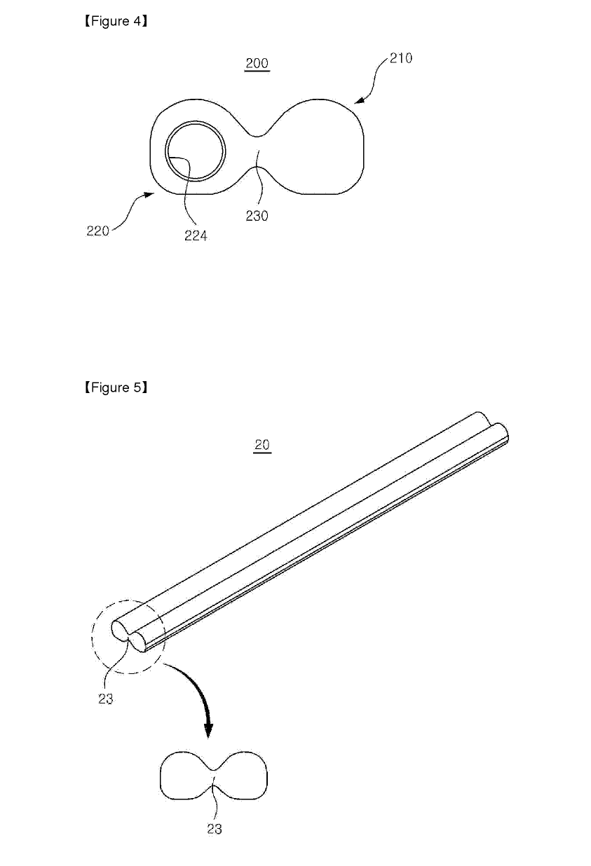

FIG. 3 is a plan view illustrating the injector cup unit of FIG. 2. FIG. 4 is a bottom view illustrating the injector cup unit of FIG. 2.

Referring to FIGS. 1 to 4, a fuel injection assembly 10 according to the current embodiment may be disposed between an engine (not shown) used in, e.g., a vehicle and a fuel injection pump (not shown) to inject fuel to the engine at high pressure. The fuel injection assembly 10 may include a fuel injection pipe 100 and injector cup units 200 for connecting the fuel injection pipe 100.

Regarding directions, the term “a longitudinal direction” may denote a direction along the length of the fuel injection pipe 100 of FIG. 1, or a direction along the length of a steel bar 20 of FIG. 5, and the terms “upward” and “downward” may denote a direction from a recess coupler part 216 of an injector cup 210 of FIG. 7 to an insertion part 214 and the opposite direction thereto.

The fuel injection pipe 100 may have a sealed end and be filled with fuel.

That is, the fuel injection pipe 100 may include an introduction pipe 110 on a side surface, and a fuel supply pipe may be connected to the introduction pipe 110 so that fuel supplied from the fuel supply pipe can be introduced into the fuel injection pipe 100 through the introduction pipe 110.

One or more of the injector cup units 200 may be connected in parallel to another side surface of the fuel injection pipe 100 and be spaced a predetermined distance from one another in the longitudinal direction. Recess coupler parts 216 and 226 of the injector cup units 200, which will be described later, are used to weld the injector cup units 200 to the fuel injection pipe 100 more securely and stably.

The injector cup unit 200 may be used to inject, at high pressure, fuel introduced from the fuel injection pipe 100, to the engine through an injector (not shown) and may include the injector cup 210 and an injector holder 220.

In particular, the injector cup 210 and the injector holder 220 may be integrally formed and be simultaneously formed from the steel bar 20 illustrated in FIG. 5.

The injector cup 210 may have a cup shape with a closed end and an open end. A fuel communication part 212 and the insertion part 214 communicating with the fuel communication part 212 may be disposed in the injector cup 210.

The fuel communication part 212 may communicate with the inside of the fuel injection pipe 100 and function as a passage through which fuel filling the fuel injection pipe 100 is introduced. The fuel introduced into the injector cup 210 through the fuel communication part 212 can be injected at high pressure into the engine through the injector (not shown).

The injector (not shown) is inserted in the insertion part 214 as a recess and is fixed to the injector cup 210. To this end, a separate coupling member such as a clip may be used.

The injector cup 210 may include the recess coupler part 216 that is used to weld the injector cup 210 to the fuel injection pipe 100. The recess coupler part 216 may be formed to conform with an outer surface of the fuel injection pipe 100.

That is, the recess coupler part 216 may have a round recess shape corresponding to the radius of curvature of the outer surface of the fuel injection pipe 100. The fuel communication part 212 may be disposed in the recess coupler part 216.

The injector cup 210 may be integrally formed with the injector holder 220 to constitute the injector cup unit 200. The injector holder 220 may support the injector cup 210 and function as a medium for coupling the injector cup 210, i.e., the fuel injection pipe 100 welded to the injector cup 210, to the engine.

That is, the injector holder 220 may include a coupling part 224 having a hole shape, and the fuel injection pipe 100 may be coupled to the engine by a separate coupling member such as a bolt passing through the coupling part 224.

Like the injector cup 210, the injector holder 220 may include the recess coupler part 226 conforming with the outer surface of the fuel injection pipe 100, and the recess coupler part 226 may have a round recess shape corresponding to the radius of curvature of the outer surface of the fuel injection pipe 100.

The injector holder 220 may have a shape corresponding to that of the injector cup 210. Thus, the injector cup unit 200 may have an approximately dumbbell-shaped cross section.

Alternatively, at least one of the injector holder 220 and the injector cup 210 may have a flat surface on at least one portion of the outer surface thereof.

A portion of the injector cup unit 200 for connecting the injector holder 220 and the injector cup 210 may be recessed upward and downward.

In particular, the injector cup unit 200 may include the injector holder 220 that may be integrally formed with the injector cup 210 through a connecting recess part 230.

In other words, the connecting recess part 230 may connect the injector holder 220 and the injector cup 210 to each other, and be recessed upward and downward.

Thus, the connecting recess part 230 makes it possible to form the injector cup unit 200 through a single integration process, which is simpler than a process of separately forming the injector cup 210 and the injector holder 220 and then welding the injector cup 210 and the injector holder 220 to each other.

That is, in the related art, an injector cup constituting an injector cup unit is machined, and an injector holder is casted and then is welded to the injector cup.

This may cause a decrease in dimension accuracy due to the casting, deformation due to the welding, a productivity decrease due to a complicated process, and a decrease in mechanical properties.

However, since the injector cup 210 and the injector holder 220 are integrally formed according to the current embodiment, a welding process and a casting process are unnecessary, thereby improving productivity and preventing defects occurring in a welding process and a casting process. Furthermore, the mechanical properties of a material obtained through a sintering process can be improved.

FIGS. 5 to 7 are perspective views illustrating a process of fabricating an injector cup unit for connecting a fuel injection pipe according to an embodiment of the present invention.

Referring to FIG. 5, the steel bar 20 may be provided to fabricate the injector cup unit 200.

The steel bar 20 may include parent bodies 21 of the injector cups 210 and parent bodies 22 of the injector holders 220 which are integrally formed with the parent bodies 21. The parent bodies 21 and 22 may be continuously connected in the longitudinal direction. A cross-section of the steel bar 20 may be constant in the longitudinal direction.

That is, the steel bar 20 may have an approximately dumbbell-shaped cross section, or a flat surface may be formed on a portion of the outer surface thereof.

A recess connection part 23, which is recessed upward and downward, may be disposed in approximately the middle of the steel bar 20.

The recess connection part 23 may connect the parent bodies 21 and 22 to each other. As a result, the injector cup 210 and the injector holder 220, formed by cutting and processing the steel bar 20, may be integrated using the recess connection part 23.

The steel bar 20 may be fabricated from a parent body material, i.e., stainless steel through at least one of shape rolling, shaped drawing, shape extrusion, and die forging.

In other words, the steel bar 20 may be formed by performing a shape rolling process on a stainless steel round bar as a material used to form the injector cup unit 200, or performing a heat treatment process and a shaped drawing process thereon.

Alternatively, a shape extrusion process may be used, but processes of forming the steel bar 20 are not limited thereto. Thus, any process of forming an elongated body having a dumbbell shape with a constant cross section can be used.

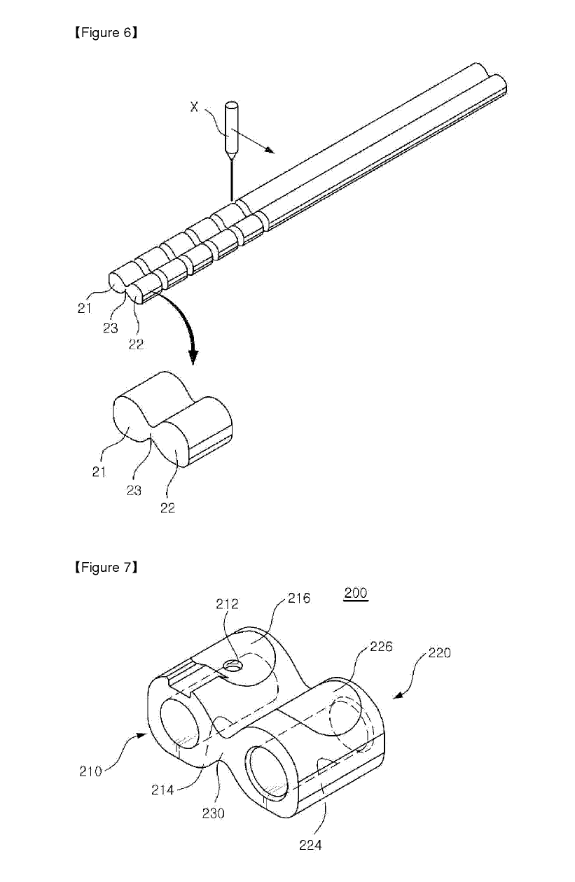

Referring to FIG. 6, after the steel bar 20 is provided, the steel bar 20 is cut to a preset length by using a cutter X. Accordingly, the parent body 21 and the parent body 22 integrally formed with the parent body 21 are fabricated.

The lengths of the parent bodies 21 and 22 may correspond to those of the injector cup 210 and the injector holder 220.

Referring to FIG. 7, after the parent body 21 and the parent body 22 integrally formed with the parent body 21 are fabricated, an additional process may be performed to fabricate the injector cup 210 and the injector holder 220 integrally formed with the injector cup 210.

The fabricating of the injector cup 210 may include fabricating the fuel communication part 212 communicating with the fuel injection pipe 100, and fabricating the insertion part 214 coupled to the injector (not shown). The fabricating of the injector holder 220 may include fabricating the coupling part 224 for coupling to the engine.

The fabricating of the injector cup 210 may include fabricating the recess coupler part 216 conforming with the outer surface of the fuel injection pipe 100. The fabricating of the injector holder 220 integrally formed with the injector cup 210 may include fabricating the recess coupler part 226 conforming with the outer surface of the fuel injection pipe 100.

The central axis of the injector cup 210 may be in parallel to that of the injector holder 220 before the recess coupler parts 216 and 226 are fabricated. The fabricating of the recess coupler parts 216 and 226 can be further facilitated.

The above described processes are not specifically limited, and thus, various processes may be selected according to the intention of a person skilled in the art.

According to the embodiments of the present invention, an injector cup unit for connecting a fuel injection pipe and a method of fabricating the injector cup unit are adapted for improving dimension accuracy and mechanical properties.

In addition, a fabrication process is simplified to decrease fabrication process time and fabrication costs.

In addition, an additional process is facilitated to maximize productivity.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of fabricating an injector cup unit for connecting a fuel injection pipe, comprising:
providing a steel bar in which parent bodies of injector cups and parent bodies of injector holders, integrally formed with the parent bodies of the injector cups, are continuously connected in a longitudinal direction thereof;
cutting the steel bar to a preset length to fabricate the parent body of the injector cup and the parent body of the injector holder; and
processing the parent body of the injector cup and the parent body of the injector holder to fabricate the injector cup and the injector holder integrally formed with the injector cup.

2. The method of claim 1, wherein the steel bar has a constant cross section and comprises a recess connection part that is elongated in the longitudinal direction to connect the parent body of the injector cup and the parent body of the injector holder.

3. The method of claim 2, wherein the recess connection part is recessed upward and downward.

4. The method of claim 1, wherein the fabricating of the injector cup comprises fabricating a fuel communication part communicating with the fuel injection pipe, and fabricating an insertion part coupled to an injector.

5. The method of claim 1, wherein the fabricating of the injector holder comprises fabricating a coupling part for coupling to an engine.

6. The method of claim 1, wherein the providing of the steel bar comprises fabricating a coupling part in the injector holder for coupling to an engine.

7. The method of claim 1, wherein the fabricating of the injector cup and the injector holder integrally formed with the injector cup comprises fabricating recess coupler parts that individually conform with an outer surface of the fuel injection pipe.

8. The method of claim 1, wherein the steel bar is fabricated from a parent body material through at least one of shape rolling, shaped drawing, shape extrusion, and die forging.

9. The method of claim 8, wherein the parent body material comprises stainless steel.

10. An injector cup unit for connecting a fuel injection pipe, comprising:
an injector cup configured to inject fuel introduced from the fuel injection pipe, through an injector; and
an injector holder integrally formed with the injector cup and comprising a coupling part for coupling to an engine.

11. The injector cup unit of claim 10, wherein the injector cup and the injector holder are integrated through a connecting recess part recessed upward and downward.
